(19) United States
(12) Patent Application Publication
(10) Pub. No.: US 2014/0067161 A1
(43) Pub. Date: Mar. 6, 2014

(54) SYSTEM FOR PREVENTING RELAY ATTACK FOR VEHICLE ENTRY

(71) Applicants: Bruce D. Conner, Ypsilanti, MI (US); Vipul M. Patel, Northville, MI (US)

(72) Inventors: Bruce D. Conner, Ypsilanti, MI (US); Vipul M. Patel, Northville, MI (US)

(73) Assignee: GM GLOBAL TECHNOLOGY OPERATIONS LLC, Detroit, MI (US)

(21) Appl. No.: 13/604,164

(22) Filed: Sep. 5, 2012

(51) Int. Cl. G06F 17/00

(52) U.S. Cl. 701/2

(57) ABSTRACT

A system for preventing a relay attack on a vehicle is provided. The system includes a base unit positioned in the vehicle and operably connected to at least one vehicle system. The base unit is configured to obtain position information of the base unit. The system further includes a portable operating unit configured to obtain and transmit position information of the portable operating unit to the base unit. The base unit determines the position of the portable operating unit relative to the base unit and selectively controls operation of the at least one vehicle system based on the determination of the position of the portable operating system relative to the base unit.

### FIELD OF THE INVENTION

The subject invention relates to a system for preventing a relay attack against a vehicle having systems which may be operated based on the proximity of an authorized user to the vehicle.

### BACKGROUND

Traditional proximity based vehicle systems allow an authorized user, i.e., a user holding an authorized key fob, to operate a vehicle system when the authorized user is within a predetermined distance from the vehicle. One example of a proximity based vehicle system is a smart key system. In a smart key system, a user holding the authorized key fob, may actuate door locks of the vehicle without mechanically inserting a key into a lock cylinder. In the smart key system, a user may actuate a switch on the exterior of the vehicle. The switch may be actuated by operation of, for example, a door handle or a push button on the exterior of the vehicle.

In response to operation of the switch, the vehicle transmits a low frequency (LF) signal. The LF signal is typically 125 Hz and has a limited range, for example, up to 3 meters. If the signal is received by an authorized key fob, the key fob transmits a reply signal to the vehicle. The reply signal is typically a higher frequency signal, such as a radio frequency (RF) signal, and may have a range of, for example, 100-150 meters depending on the design of the system. The power level that the key fob can transmit is limited by FCC regulations, and thus, the distance over which a key fob may transmit is limited to the range above.

The vehicle, upon receiving the reply from the key fob, then operates the desired vehicle system, for example, the door locks. Accordingly, a user with an authorized key fob may actuate the vehicle door locks when the user is within the predetermined range without mechanically inserting a key into a cylinder. However, such a system may be susceptible to relay attacks, allowing unauthorized individuals to gain access to the vehicle.

In a relay attack, a first unauthorized individual is equipped with a first transceiver and is positioned near the vehicle, within the limited range (e.g., 3 meters) of the signal transmitted from the vehicle. The first unauthorized individual actuates the switch when the authorized user moves away from vehicle. The first transceiver receives the LF signal from the vehicle intended for the authorized key fob, and translates the signal to an RF signal, which may be transmitted over a greater distance. The first transceiver then transmits the RF signal to a second transceiver positioned with a second unauthorized individual. The second transceiver translates the RF signal back into a LF signal and transmits the LF signal to the authorized key fob positioned with the authorized user.

The second unauthorized individual is positioned near the authorized user with the authorized fob. However, the second unauthorized individual may be positioned at a distance greater than 3 meters depending on the power available to the second transceiver.

The authorized key fob receives the LF signal from the second transceiver and transmits a reply signal. The reply signal is an RF signal. The reply signal may be received by the vehicle if the authorized user is in range, e.g, 100-150 meters from the vehicle. Alternatively, the second transceiver may receive the reply signal and retransmit the reply signal over a greater distance at a higher power level. Thus, in a relay attack, first and second transceivers positioned with first and second unauthorized individuals, effectively increase the range over which signals between the vehicle and authorized key fob are transmitted by relaying the signals between the vehicle and the authorized key fob.

The vehicle, upon receiving the authorized key fob reply signal, either directly from the key fob, or relayed from the second transceiver, operates the desired vehicle system. Thus, where the door locks are the desired vehicle system to be operated, the first unauthorized individual, positioned near the vehicle, may gain access to the vehicle. Similar unauthorized operation of proximity based vehicle systems, such as an ignition system, may occur through relay attacks as well.

Accordingly, it is desirable to provide a system to prevent a relay attack by determining the position of the authorized user relative to the vehicle prior to operating the desired proximity based vehicle system.

### SUMMARY OF THE INVENTION

In one exemplary embodiment of the invention there is provided a system for preventing a relay attack on a vehicle. The system includes a base unit positioned in the vehicle and operably connected to at least one vehicle system. The base unit is configured to obtain position information of the base unit. The system further includes a portable operating unit configured to obtain and transmit position information of the portable operating unit to the base unit. The base unit determines the position of the portable operating unit relative to the base unit and selectively controls operation of the at least one vehicle system based on the determination of the position of the portable operating system relative to the base unit.

In another exemplary embodiment of the invention there is provided a method at a base unit for preventing a relay attack on a vehicle, said base unit comprising a receiver, a transmitter and a control unit. The method includes receiving, by the base unit, a signal from at least one vehicle system of the vehicle requesting operation of the vehicle system, transmitting, by the base unit, a request message to a portable operating unit, and receiving, by the base unit, a response message from the portable operating unit, the response message including position information of the portable operating unit. The method further includes obtaining, by the base unit, position information of the base unit, determining, by the base unit, a position of the portable operating unit relative to the base unit based on the received position information of the portable operating unit and the position information of the base unit, and controlling, by the base unit, operation of the at least one vehicle system based on the position of portable operating unit relative to the base unit.

In yet another exemplary embodiment of the invention there is provided a method at a portable operating unit for preventing a relay attack on a vehicle, the portable operating unit comprising a receiver, a transmitter, a control unit, and a GPS unit. The method includes receiving, by the portable operating unit, a request message from a base unit positioned at the vehicle, obtaining, by the portable operating unit, position information of the portable operating unit via the GPS unit, generating, by the portable operating unit, a response message including the position information of said portable operating unit, and transmitting, by the portable operating unit, the response message to the base unit.

In still yet another exemplary embodiment of the invention there is provided a base unit for preventing a relay attack on a vehicle, the base unit positioned at the vehicle and operably connected to at least one vehicle system. The base unit includes a control unit, a transmitter configured to transmit a request message to a portable operating unit and a receiver configured to receive a response message from the portable operating unit containing position information of the portable operating unit. The base unit is configured to selectively operate the at least one vehicle system based on the position information of the portable operating unit.

In yet still another exemplary embodiment of the invention there is provided a portable operating unit for preventing a relay attack on a vehicle. The portable operating unit includes a control unit, a receiver configured to receive a request message from a base unit, a GPS unit configured to obtain position information of the portable operating unit, and a transmitter configured to transmit a response message including the position information of the portable operating unit to the base unit.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a diagram of an example of a relay attack against a vehicle;

FIG. 2 is a diagram illustrating a system to prevent a relay attack against a vehicle according to an exemplary embodiment;

FIG. 3 is a diagram illustrating a base unit according to an exemplary embodiment;

FIG. 4 is a diagram illustrating a portable operating unit according to an exemplary embodiment;

FIG. 5 is a flowchart illustrating a method performed at the base unit according to an exemplary embodiment; and

FIG. 6 is a flowchart illustrating a method performed at the portable operating unit according to an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

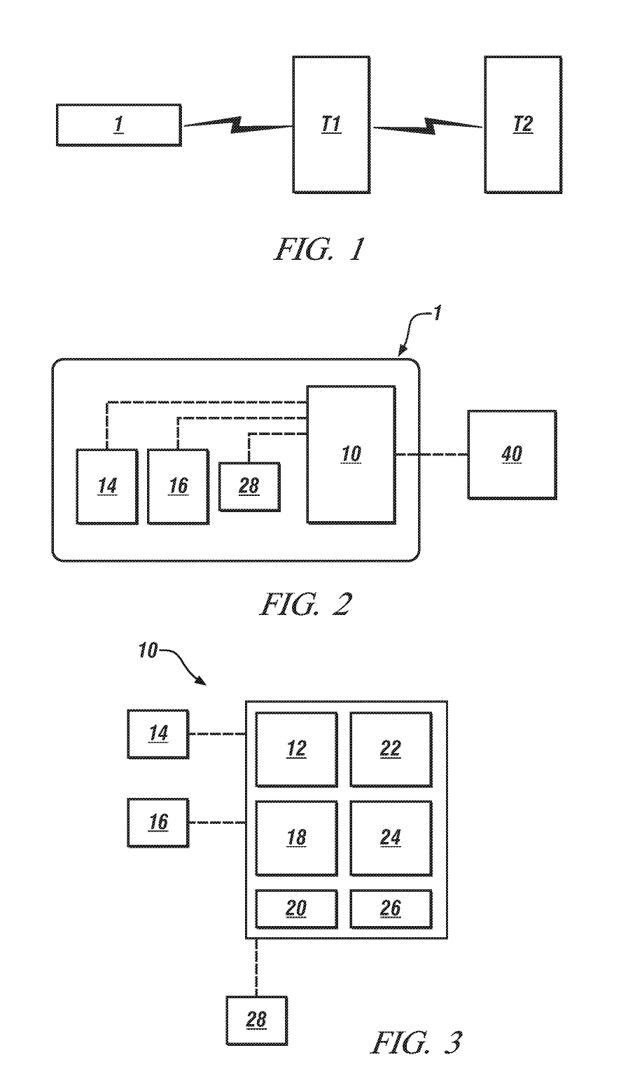

In accordance with an exemplary embodiment of the subject invention, and with reference to FIGS. 1 and 2, the system generally includes a base unit 10 configured to be positioned in a vehicle 1 and a portable operating unit 40. In an exemplary embodiment, base unit 10 and portable operating unit 40 are used to operate a proximity based vehicle system of the vehicle 1. In a proximity based system, an authorized user may selectively control various operations to be performed at the vehicle 1 when the authorized user, i.e., a user with an authorized portable operating unit 40, is positioned within a predetermined distance of the vehicle 1. For example, a user may actuate a door lock of the vehicle or start the vehicle engine without mechanically inserting a key into a corresponding key cylinder of the vehicle 1. In addition, the base unit 10 and portable operating unit 40 may be used to disable various vehicle systems and functions.

The predetermined distance may be, for example, a maximum distance or range that the vehicle 1 or base unit 10 may successfully transmit a signal. This range may vary depending on the strength of transmitters positioned at the vehicle 1 and portable operating unit 40. In an exemplary embodiment, the base unit 10 transmits a low frequency (LF) signal that has a maximum transmitting distance, or range, of approximately 2-3 meters. Accordingly, in an exemplary embodiment, the predetermined distance is, for example, between 2-3 meters. However, the predetermined distance is not limited to this range, and may be a shorter or greater distance depending on the transmitter used in the vehicle 1 or base unit 10, and the amount of power supplied thereto.

With reference to FIG. 2, in an exemplary embodiment of the subject invention, the base unit 10 is positioned at the vehicle 1. The base unit 10 is operably connected to various vehicle systems and is configured to selectively control the various vehicle systems. For example, the base unit 10 may be operably connected to, and in communication with, a door lock system 14 and vehicle ignition system 16. The base unit 10 may be operably connected to other vehicle systems as well. In an exemplary embodiment, the door lock system 14 and vehicle ignition system 16 are proximity based systems, and may be operated when the authorized user is within the predetermined distance from the vehicle. The door lock system 14 may include locks for vehicle doors that provide access to the passenger cabin and/or other areas of the vehicle, such as the trunk. A lock for a trunk may be operated separately from the locks for vehicle doors.

With reference to FIG. 3, the base unit 10 includes a first control unit 12, a first transmitter 18 and a first receiver 20. The base unit 10 may be operably and communicably connected to the various proximity based vehicle systems, such as the door lock system 14 and vehicle ignition system 16, via the first control unit 12. The first transmitter 18 and first receiver 20 are configured to transmit and receive signals or electromagnetic waves. The signals or electromagnetic waves may include a message or messages containing data to be transmitted between the base unit 10 and the portable operating unit 40. In an exemplary embodiment, the first transmitter 18 is a LF transmitter configured to transmit a LF signal and the receiver 20 is a radio frequency (RF) receiver configured to receive a RF signal. The base unit 10 may further include, or be operably and communicably connected to a first memory storage unit 22, a first input/output (I/O) module 24, and/or other vehicle systems, components and/or modules, such as a first Global Positioning System (GPS) unit 26.

With reference to FIG. 2, the vehicle 1 also includes at least one switch 28 configured to initiate an operation of a proximity based vehicle system. For example, a switch 28 may be used to initiate an operation of the door lock system 14 to unlock a door or of the vehicle ignition system 16 start the vehicle engine.

The switch 28 may be in the form of, for example, a door handle, or be connected to the door handle and operable upon actuation of the door handle. The switch 28 may also be a push-button located on the door handle or elsewhere on, or within, the vehicle, so that the push-button may be accessed by the authorized user of the vehicle. The examples above are non-limiting, and it is understood that the at least one switch 28 may be embodied as other suitable mechanisms as well. It is also understood that multiple switches 28 may be used to initiate a variety of operations not limited to those described above.

In a method of operation of the base unit 10, and with reference to FIG. 5, a signal is transmitted to, and received by, the base unit 10 in response to actuation of the switch 28 at 105. The base unit 10 is configured to generate a request message M1 at 110 in response to the signal, and the transmitter 18 is configured to transmit the request message M1 to the portable operating unit 40 at 115.

The portable operating unit 40 may be, for example, a key fob. Alternatively, the portable operating unit 40 may be a portable electronic device, such as a cellular phone. Other non-limiting examples of portable electronic devices include a personal digital assistant, a portable GPS device, a laptop computer, tablet computer, or other similar device capable of wireless or network communication. Alternatively, the portable operating unit 40 may be paired with a portable electronic device and exchange data with the portable electronic device.

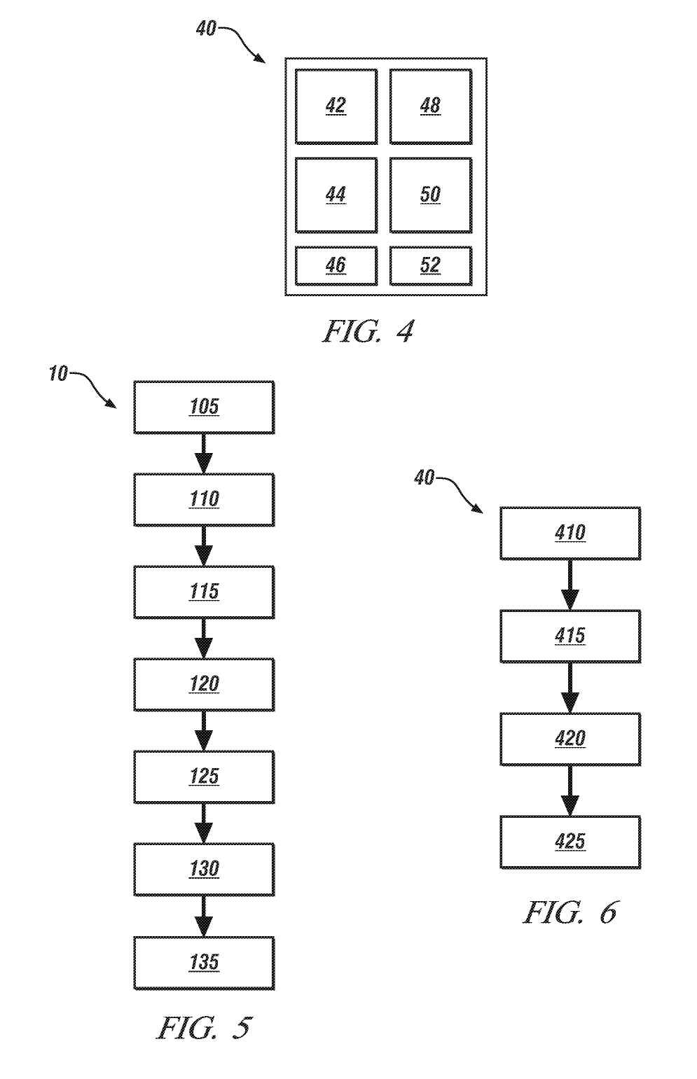

With reference to FIG. 4, in an exemplary embodiment, the portable operating unit 40 includes a second receiver 42, a second transmitter 44, a second control unit 46 and a second GPS unit 48. The operating unit 40 may be powered by a battery (not shown) or similar rechargeable and/or replaceable power source, or other mechanism suitable for providing sufficient power to the components of the portable operating unit 40.

The second receiver 42 and the second transmitter 44 are respectively configured to receive and transmit signals or electromagnetic waves during communication with the base unit 10. The signals or electromagnetic waves may include a message or messages containing data to be transmitted between the portable operating unit 40 and the base unit 10. In an exemplary embodiment, the second receiver 42 is a LF receiver configured to receive a LF signal and the second transmitter 44 is a RF transmitter configured to transmit a RF signal.

The second control unit 46 is operably and communicably connected to the second receiver 42, second transmitter 44, and second GPS unit 48. The second control unit 46 may further be operably and communicably connected with a second memory storage unit 50, second I/O module 52, and/or other components, modules and systems of the operating unit 40.

With reference to FIGS. 4 and 6, the second receiver 42 is configured to receive the request message M1 from the base unit 10 of the vehicle 1 at 410. In response to receipt of the request message M1, the second control unit 46 is configured to obtain position information of the portable operating unit 40 at 415.

In an exemplary embodiment, the second control unit 46 may obtain the position information of the portable operating unit 40 from the second GPS unit 48. The second GPS unit 48 communicates with GPS satellites to determine position information of the second GPS unit 48 and accordingly, the portable operating unit 40. The position information may include position coordinates.

In another exemplary embodiment, the second control unit 46 may obtain the position information of the portable operating unit 40 from the second memory storage device 50. In this embodiment, the second GPS unit 48 may determine the position information at predetermined intervals and store the information in the second memory storage unit 50. It is also understood that the second control unit 46 may obtain position information from a portable electronic device paired to the portable operating unit 40.

The second control unit 46 is configured to generate a response message M2 in response to the request message M1 received from the base unit 10 of the vehicle 1 at 420. The response message M2 includes the obtained position information. The second transmitter 44 is configured to transmit the response message M2 to the receiver 20 of the base unit 10 at the vehicle 1 at 425.

The base unit 10 obtains vehicle position information to determine the location of the vehicle. Vehicle position information may be obtained through a variety of methods. In one exemplary embodiment, the base unit 10 includes, or is operably and communicably connected to, the first GPS unit 26 positioned in the vehicle 1. The vehicle GPS unit 26 communicates with GPS satellites and obtains vehicle position information in the form of GPS coordinates. The first GPS unit 26 may obtain the vehicle position information at predetermined intervals and store the information in the first memory storage unit 22. Alternatively, the base unit 10 may request the first GPS unit 26 to obtain the vehicle position information upon the happening of a predetermined event, for example, transmission of the request message M1 to the portable operating unit 40.

In another exemplary embodiment, the portable operating unit 40, with the second GPS unit 48, may transmit position information to base unit 10 before the authorized user exits the vehicle 1, or while the user is in close proximity to the vehicle 1, for example, when the authorized user is within the predetermined distance from the vehicle 1. This position information may be stored in the first memory storage unit 22 as the vehicle position information.

Transmission of the position information from the portable operating unit 40 to the vehicle 1 may occur upon an action by the authorized user to do so. Alternatively, the transmission may occur automatically upon the happening of a predetermined event, such as the vehicle 1 being turned off. This arrangement may be useful in vehicles which are not equipped with a GPS unit. Thus, the base unit 10 may obtain the vehicle position information either from the first memory storage unit 22 or directly from the vehicle GPS unit 26.

With further reference to the method shown in FIG. 5, the base unit 10 is configured to receive the response message M2 from the portable operating unit 40 at 120. The response message M2 includes the position information of the portable operating unit 40. At 125, the base unit 10 retrieves the vehicle position information. The position of the vehicle, included in the vehicle position information, corresponds to a position of the base station 10. At 130, the base unit 10 determines the position of the operating unit 40 relative to the base unit 10 based on the position information of the portable operating unit 40 received in response message M2 and the vehicle position information.

At 135, the base unit 10 selectively operates the desired proximity based vehicle system based on the determined relative position of the operating unit 40 to the base unit 10. If the base unit 10 determines that the portable operating unit 40 is not within a predetermined distance from the vehicle, the base unit 10 will not operate the desired proximity based vehicle system of the vehicle 1. Conversely, if the base unit 10 determines that the portable operating unit 40 is within a predetermined distance from vehicle 1, the base unit 10 will operate the desired proximity based vehicle system.

In operation of the exemplary embodiments described above, an attempted relay attack may be deterred. For example, with reference to FIGS. 3-6, when the switch 28 is actuated by a first unauthorized individual to operate a proximity based vehicle system, the base unit 10 generates and transmits a request message M1. In an exemplary embodiment, the proximity based vehicle system may be a door lock system 14. Thus, the first unauthorized individual may actuate the switch 28 in an effort to operate the door locks of the vehicle 1. In another exemplary embodiment, the proximity based vehicle system may be a vehicle ignition system 16. In this example, a first unauthorized individual may already have access to a passenger cabin of the vehicle 1 and seeks to start the engine of the vehicle 1.

In a relay attack, the portable operating unit 40 is positioned, for example, with the authorized user, outside of the predetermined distance, i.e., a transmitting range of the base unit 10. The transmitting range of the base unit 10 may typically be 2-3 meters. Thus, the portable operating unit 40 does not directly receive the request message M1 from the base unit 10. However, with reference to FIG. 1, the first unauthorized individual, positioned within the transmitting range of the base unit 10, uses a first transceiver T1 to receive and relay the request message M1 to the second transceiver T2. The second transceiver T2 then relays the request message M1 to the portable operating unit 40.

In response to receiving the relayed request message M1, as shown in FIG. 6, the second control unit 46 of the portable operating unit 40 obtains location information from the remote GPS unit 48, and generates a response message M2. In a relay attack, the response message M2 may be transmitted directly to the vehicle 1 from the authorized key fob or via the second transceiver T2 to operate the proximity based system. However, in an exemplary embodiment, the response message M2 transmitted from the portable operating unit 40 includes position information of the portable operating unit. The response message M2 with the position information is received at the base unit 10.

With further reference to FIGS. 3-6, in response to receiving the response message M2, the base unit 10 obtains vehicle position information, either from storage unit 22 or the vehicle GPS unit 26. The base unit 10 compares the vehicle position information with position information of the portable operating unit 40 received in the response message M2. If the received position information, i.e., position information of the portable operating unit 40, indicates that the operating unit is located at a distance which exceeds the predetermined distance from the vehicle 1, then the base unit 10 determines that a relay attack is taking place, and prevents operation of the desired vehicle system. For example, the base unit 10 may prevent actuation of the door lock system 14 if it is determined that a relay attack is taking place. Thus, the unauthorized actuation of switch 28 in an effort to actuate the door lock system 14 is unsuccessful.

Alternatively, the switch 28 may be actuated by the authorized user in possession of the portable operating unit 40. As detailed above, actuation of the switch 28 causes the base unit 10 to generate and transmit the request message M1. The request message M1 is received by the portable operating unit 40 if the portable operating unit 40 is within the predetermined distance, for example, within 2-3 meters of the vehicle 1. The second control unit 46 receives the request message M1, obtains position information of the portable operating unit 40 from the remote GPS unit 48, and transmits a response message M2 containing the position information. The base unit 10 receives the response message M2 and compares the position information with the vehicle position information. Here, the base unit 10 determines that the portable operating unit 40 is within the predetermined distance from the vehicle 1, and that a relay attack is not in progress. Accordingly, the base unit 10 operates the door lock system 14 to actuate the door locks, thus allowing the authorized user to open the vehicle doors.

If the portable operating unit 40 is outside the transmission range of the vehicle 1 or base unit 10, for example, beyond 2-3 meters, and the switch 28 is activated to operate the lock system 14, the base unit 10 generates and transmits the request message M1. However, in the absence of a relay attack, and because the portable operating unit 40 is outside of the transmission range, i.e., outside of the predetermined distance, the request message is not received by the portable operating unit 40. Accordingly, a response message M2 is not generated or transmitted to the base unit 10 of the vehicle. If no response message is received, the base unit 10 will not allow proximity base system to be operated.

The first control unit 12 and second control unit 46 coordinate and control the functions and methods performed at base unit 10 and portable operating unit 40, respectively. Further, the functions and methods carried out at the base unit 10 and operating unit 40 may be carried out by the respective first control unit 12 and second control unit 46.

The first control unit 12 and second control unit 46 are provided to execute software algorithms for implementing at least in part the methods described above. In particular, the methods described herein may be at least partially embodied in the form of one or more computer readable media having computer-executable instructions for practicing the method. The computer-readable media can comprise one or more volatile memory devices and/or one or more non-volatile memory devices wherein when the computer-executable instructions are loaded into one or more of the memory devices and executed by the first control unit 12 and second control unit 46, the first control unit 12 and second control unit 46 become apparatuses for practicing the invention.

In one exemplary embodiment, the first control unit 12 and second control unit 46 include, respectively, a microprocessor, a non-volatile memory device such as a read-only memory, a volatile memory such as a random access memory and the I/O interfaces 24, 52. The microprocessor operably communicates with the ROM, the RAM, and the I/O interfaces 24, 52. The computer readable media including ROM and RAM may be implemented using any of a number of known memory devices such as PROMs, EPROMs, EEPROMS, flash memory or any other electric, magnetic, optical or combination memory device capable of storing data, some of which represent executable instructions used by the microprocessor.

While the invention has been described with reference to the exemplary embodiments, it will be understood by those skilled in the art that various changes may be made and equivalents may be substituted for elements thereof without departing from the scope of invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system for preventing a relay attack on a vehicle, the system comprising:
a base unit positioned in said vehicle and operably connected to at least one vehicle system, said base unit configured to obtain position information of said base unit; and
a portable operating unit configured to obtain and transmit position information of said portable operating unit to said base unit, and said base unit determines the position of said portable operating unit relative to said base unit and selectively controls operation of said at least one vehicle system based on said determination of the position of said portable operating system relative to said base unit.

2. The system of claim 1, wherein said base unit comprises:
a first control unit;
a first transmitter configured to transmit a request message to said portable operating unit; and
a first receiver configured to receive a response message containing said position information from said portable operating unit.

3. The system of claim 2, where said portable operating unit comprises:
a second control unit;
a second transmitter configured to transmit said response message to said base unit;
a second receiver configured to receive said request message from said base unit; and
a Global Positioning System (GPS) unit configured to obtain said position information of said operating unit.

4. The system of claim 3, wherein the base unit is configured to receive a signal from said at least one vehicle system to actuate said at least one vehicle system, and in response to said signal, the base unit is configured to generate said request message, and said first transmitter is configured to transmit said request message to said portable operating unit.

5. The system of claim 1, wherein in response to said base unit determining that the position of said portable operating unit relative to said base unit exceeds a predetermined distance, said base unit prevents operation of said at least one vehicle system.

6. The system of claim 1, wherein in response to said base unit determining that the position of said portable operating unit relative to said base unit is within a predetermined distance, said base unit allows operation of said at least one vehicle system.

7. The system of claim 1, wherein said at least one vehicle system is a door lock system.

8. The system of claim 1, wherein said at least one vehicle system is an engine ignition system.

9. A method at a base unit for preventing a relay attack on a vehicle, said base unit comprising a receiver, a transmitter and a control unit, the method comprising:
receiving, by said base unit, a signal from at least one vehicle system of said vehicle requesting operation of said vehicle system;
transmitting, by said base unit, a request message to a portable operating unit;
receiving, by said base unit, a response message from said portable operating unit, said response message including position information of said portable operating unit;
obtaining, by said base unit, position information of said base unit;
determining, by said base unit, a position of said portable operating unit relative to said base unit based on said received position information of said portable operating unit and said position information of said base unit; and
controlling, by said base unit, operation of said at least one vehicle system based on said position of portable operating unit relative to said base unit.

10. The method of claim 9, wherein controlling operation of said vehicle system further comprises allowing operation of said vehicle system in response to said position of said portable operating unit relative to said base unit being within a predetermined distance.

11. The method of claim 9, wherein controlling operation of said vehicle system further comprises preventing operation of said vehicle system in response to said position of said portable operating unit relative to said base unit exceeding a predetermined distance.

12. The method of claim 9, wherein said position information of said base unit is obtained from a Global Positioning System (GPS) unit of said vehicle.

13. The method of claim 9, wherein said position information of said base unit is obtained from said portable operating unit.

14. A method at a portable operating unit for preventing a relay attack on a vehicle, said portable operating unit comprising a receiver, a transmitter, a control unit, and a Global Position System (GPS) unit, the method comprising:
receiving, by said portable operating unit, a request message from a base unit positioned at said vehicle;
obtaining, by said portable operating unit, position information of said portable operating unit via said GPS unit;
generating, by said portable operating unit, a response message including said position information of said portable operating unit; and
transmitting, by said portable operating unit, said response message to said base unit.

15. A base unit for preventing a relay attack on a vehicle, said base unit positioned at said vehicle and operably connected to at least one vehicle system, said base unit comprising:
a control unit;
a transmitter configured to transmit a request message to a portable operating unit; and a receiver configured to receive a response message from said portable operating unit containing position information of said portable operating unit, said base unit configured to selectively operate said at least one vehicle system based on said position information of said portable operating unit.

16. The base unit of claim 15, wherein said base unit is configured to receive a signal from said at least one vehicle system to actuate said at least one vehicle system, and in response to said signal, said base unit is configured to generate said request message and said transmitter is configured to transmit said request message to said portable operating unit.

17. The base unit of claim 15, wherein said base unit is configured to obtain position information of said base unit, determine a distance between said base unit and portable operating unit based on said position information of said base unit and position information of said portable operating unit, and allow operation of said at least one vehicle system when said distance is less than a predetermined distance.

18. The base unit of claim 15, wherein said base unit is configured to obtain position information of said base unit, determine a distance between the base unit and portable operating unit based on said position information of said base unit and position information of said portable operating unit, and prevent operation of said at least one vehicle system when said distance exceeds a predetermined distance.

19. A portable operating unit for preventing a relay attack on a vehicle, said portable operating unit comprising:
a control unit;
a receiver configured to receive a request message from a base unit;
a Global Positioning System (GPS) unit configured to obtain position information of said portable operating unit; and
a transmitter configured to transmit a response message including said position information of said portable operating unit to said base unit.

20. The portable operating unit of claim 19, wherein the portable operating unit is a key fob or cellular phone.
